(19) United States
(12) Patent Application Publication
(10) Pub. No.: US 2024/0330394 A1
(43) Pub. Date: Oct. 3, 2024

(54) INFORMATION PROCESSING METHOD AND APPARATUS, TERMINAL AND STORAGE MEDIUM

(71) Applicant: Beijing Zitiao Network Technology Co., Ltd., Beijing (CN)

(72) Inventors: Bofei ZHANG, Beijing (CN); Liaoyuan NING, Beijing (CN); Xinru ZHANG, Beijing (CN); Fanxin DENG, Beijing (CN); Bingyi WANG, Beijing (CN)

(21) Appl. No.: 18/708,521

(22) PCT Filed: Dec. 9, 2022
(86) PCT No.: PCT/CN2022/138018

§ 371 Date: May 8, 2024

(30) Foreign Application Priority Data
Dec. 21, 2021 (CN) 202111574355.8

(51) Int. Cl. G06F 16/958; G06F 16/957

(52) U.S. Cl. CPC G06F 16/958; G06F 16/957

(57) ABSTRACT

The present disclosure provides an information processing method and apparatus, a terminal, and a storage medium. The information processing method according to the present disclosure includes the following steps performed by a plug-in of a browser: obtaining first information of a first page of a first system; based on the first information, determining, in a second system, second information associated with the first information; and displaying, on the first page, a control associated with the second information if the first page is displayed in the browser, wherein a function of the control is associated with the second information. According to the present disclosure, a user can conveniently perform an operation associated with the second information by means of the control.

### CROSS-REFERENCE TO RELATED APPLICATION

This application is based on and claims priority to Chinese patent application No. 202111574355.8, filed on Dec. 21, 2021, and entitled “INFORMATION PROCESSING METHOD AND APPARATUS, TERMINAL AND STORAGE MEDIUM”, the entire contents of which are herein incorporated by reference.

### FIELD

The present disclosure relates to the field of computer technologies, in particular to an information processing method and apparatus, a terminal and a storage medium.

### BACKGROUND

In a scenario of information management, the information of an object may be stored in different systems. For example, in the process of production and management of products, it is possible to view related information of the products, and the products often involve different related information. The different related information is stored in different systems within an enterprise. For example, the information of production links is stored in a production information system, storage information of the products is stored in a storage information system, and test information of the products is stored in a test information system. In similar scenarios, if the information in one system is viewed, the information of the object in another system possibly needs to be processed. At this time, it is necessary to repeatedly jump between two systems or even more than two systems, resulting in low operation efficiency.

### SUMMARY

The present disclosure provides an information processing method and apparatus, a terminal and a storage medium.

The present disclosure adopts the following technical solution.

In some embodiments, the present disclosure provides an information processing method, including the following steps performed by a plug-in of a browser:
obtaining first information of a first page of a first system;
determining, based on the first information, second information associated with the first information in a second system; and
in response to the first page being displayed in the browser, displaying a control associated with the second information on the first page;
wherein a function of the control is related to the second information.

In some embodiments, the present disclosure provides an information processing apparatus, including:
an obtaining unit for obtaining first information of a first page of a first system;
a determination unit for determining, based on the first information, second information associated with the first information in a second system; and
a display unit for displaying a control associated with the second information on the first page, in response to the first page being displayed in the browser;
wherein a function of the control is related to the second information. In some embodiments, the present disclosure provides a terminal including: at least one memory and at least one processor;
wherein the memory is used for storing program codes, and the processor is used for invoking the program codes stored by the memory to perform the above method.

In some embodiments, the present disclosure provides a computer-readable storage medium. The computer-readable storage medium is used for storing program codes which, when performed by a processor, cause the processor to perform the above method.

The information processing method according to the embodiment of the present disclosure will determine the second information in the second system according to the first information, and then display the control corresponding to the second information according to the second information, so that a user can perform the operation related to the second information through the control.

### BRIEF DESCRIPTION OF THE SEVERAL VIEWS OF THE DRAWINGS

The foregoing and other features, advantages, and aspects of embodiments of the present disclosure will become more apparent in conjunction with the accompanying drawings and with reference to the following specific embodiments. Throughout the accompanying drawings, the same or similar numerals indicate the same or similar elements. It should be understood that the accompanying drawings are schematic and that the parts and elements are not necessarily drawn to scale.

FIG. 1 is a flowchart of an information processing method according to an embodiment of the present disclosure;

FIG. 2 is a partial schematic diagram of a currently opened page after displaying a control according to an embodiment of the present disclosure; and

FIG. 3 is a schematic structural diagram of an electronic device according to an embodiment of the present disclosure.

### DETAILED DESCRIPTION

The embodiments of the present disclosure will be described below with reference to the drawings. Although the drawings illustrate some embodiments of the present disclosure, it should be understood that the present disclosure may be implemented in various forms, and is not limited to the embodiments set forth herein. It should be understood that the drawings and the embodiments of the present disclosure are only used for illustrative purposes and are not intended to limit the protection scope of the present disclosure.

It should be understood that the steps described in the method embodiments of the present disclosure may be performed in different sequences and/or in parallel. In addition, the method implementation modes may include additional steps and/or omit the execution of the shown steps. The scope of the present disclosure is not limited in this regard.

As used herein, term “include” and its variants should be open-ended, i.e., “including but not limited to”. Term “based on” means “based at least in part on”. Term “one embodiment” means “at least one embodiment”; term “another embodiment” means “at least one additional embodiment”; and term “some embodiments” means “at least some embodiments”. Relevant definitions of other terms will be provided in the following text.

It needs to be noted that concepts such as “first”, “second”, and the like mentioned in the present disclosure are only used to distinguish different devices, modules or units, and are not used to limit the order of functions performed by these devices, modules or units, or interdependence relationship.

It should be noted that term “one” mentioned in the present disclosure is illustrative and not restrictive, and one skilled in the art should understood that this term should be understood as “one or more” unless the context clearly indicates otherwise.

The names of massages or information exchanged among multiple devices in the embodiments of the present disclosure are only for illustrative purpose, and are not used to limit the range of these messages or the information.

The solution provided by the embodiment of the present application will be described in detail in conjunction with the accompanying drawings.

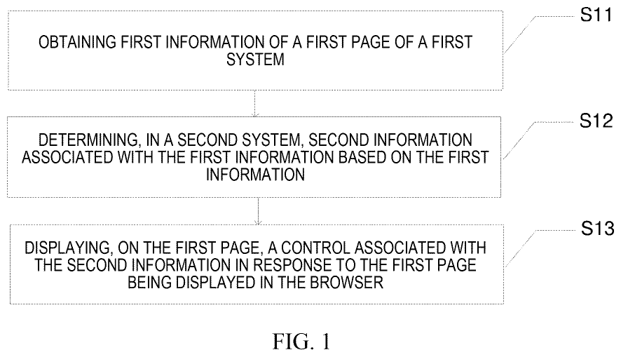

As shown in FIG. 1, FIG. 1 is a flowchart of an information processing method according to an embodiment of the present disclosure, which includes the following steps performed by a plug-in of a browser:

S11: first information of a first page of a first system is obtained.

In some embodiments, an authorization of the first system is obtained in advance, thereby obtaining the first information of the first page of the first system. In some embodiments, the first information may be obtained by opening the first page of the first system through the browser. The first information may be first information of a target object displayed in the first page, the target object may be, for example, a certain product, a certain entity and the like, and the first information is information of the target object, and may include, for example, a product code, a product name, an entity name, an entity number and the like. In some embodiments, the first information of the first page is obtained after a user performs a first predetermined operation, or the user is authorized in advance to automatically obtain the first information of the opened first page. The browser plug-in may obtain the first information of the first page from a broadcast event performed by the first system through the browser; or the first information is obtained by parsing public content of the first page.

S12: Second information associated with the first information in a second system is determined based on the first information.

In some embodiments, the second information is determined after the user performs a second predetermined operation, wherein the second system may be a system authorized in advance, and the browser plug-in may obtain the second information via an application program interface authorized by the second system. For example, the first system may be a production information system of enterprise products, and the second system may be a test information system of enterprise internal products. In some other embodiments, the first system may be a product introduction system of the enterprise products, and the second system may also be the production information system. In some embodiments, the second information is determined based on the first information, the two have a relationship, an authorization of the second system may be obtained in advance, and then the second information is obtained from the second system. In some embodiments, both the first system and the second system are pre-designated systems, and the browser plug-in is authorized by both the first system and the second system. In some embodiments, the second information may be second information of the target object. After obtaining the first information, the browser plug-in determines the target object stored in the second system and determines the second information of the target object, which may include, for example, a current progress state, importance and the like, of the target object.

S13: if the first page is displayed in the browser, a control associated with the second information is displayed on the first page.

In some embodiments, the control may be displayed in the first page. It should be noted that a function of the control is related to the second information. That is, in an embodiment of the present disclosure, controls of different users will be provided according to the different second information. As an example, the second information is production information of the target object, and the target object is, for example, a certain internal product. If the product is in a production stage, a control for following up the product may be provided. After the control is triggered, a page for following up the product in the second system is opened. If the product is being in a production state, the page for viewing a current production state is opened and an input control related to the production state is provided on this page, after the control is triggered. In some embodiments of the present disclosure, after the first information of the target object is displayed in the page of the first system, the target object in the second system will be determined according to the first information, and then the control corresponding to the second information is displayed according to the second information of the target object. In this way, the user can perform an operation related to the second information through the control. In some embodiments of the present disclosure, the function of the control changes with a change of the second information. For example, if there is no target object associated with the first information in the second system, the control may be used for establishing the page of the target object associated with the first information in the second system after being triggered. If there is a target object in the second system, the displayed page after the control is triggered may be different based on the difference of the second information of the target object. In some embodiments of the present disclosure, by associating the function of the control with the second information, such as the current state and progress of the target object, the user can perform the operation related to the second information, and the processing efficiency is improved.

In order to better explain the method according to the embodiment of the present disclosure, a specific embodiment is provided below. In this embodiment, the target object is the enterprise internal product, and the first page in the first system is opened in the browser. If the information of a certain product (target object) is displayed in the first page, the browser plug-in obtains the first information and determines the second information of the product stored in the second system according to the first information. The second system returns the second information to the plug-in, and the plug-in displays the control in the first page according to the second information. For example, if the second information shows that the product has not started research and development, a control for opening and editing detailed information of a research report of the product may be displayed, and if the second information shows that the product has started research and development, a control for following up the product may be displayed. If the second information shows that the product has been researched and developed completely and tested completely, a control for editing according to test results and making a report may be provided. The function of the provided control is related to the second information, and the function of the control may be different under different second information. In some embodiments, the second information may include progress information of the target object, and the page corresponding to the progress information of the target object may be displayed after the control is triggered. The method in some embodiments of the present disclosure enables the user to perform the operation corresponding to the second information by displaying the control associated with the second information, and the function of the control changes with the change of the second information, which is convenient for the user to operate.

In some embodiments of the present disclosure, obtaining the first information of the first page of the first system includes: obtaining the first information of the first page from a broadcast event performed by the first system through the browser if the first page of the first system meets a predetermined condition. In some embodiments, the predetermined condition may be one or more of the following: the browser loading the first page, and a change of the content of the first page. The change of the content of the first page may include the following situations: one is the change of filtering conditions (filtered results will change at this point), and the other is page turning in the first page (for example, when a displayed table is turned). For example, if the first page of the first system meets the predetermined condition, some events containing the first information will be broadcast. For example, the first page of the first system may broadcast an object identification, an object name and the like appearing on the page. The browser plug-in receives the broadcast event and obtains the first information in the broadcast event by invoking a server.

In some embodiments of the present disclosure, obtaining the first information of the first page of the first system includes: parsing the public content of the first page to obtain the first information. In some embodiments of the present disclosure, if the first page is displayed in the browser, the target object is displayed on the first page, and the first information includes the information of the target object in the first page, for example, including at least one of the object name and an object code of the target object.

In some embodiments of the present disclosure, displaying the control associated with the second information on the first page includes: displaying the control at an associated position of the target object on the first page. This allows the user to know to which object the control belongs.

In some embodiments of the present disclosure, determining the second information associated with the first information in the second system includes: transmitting the first information to the server, so that the server determines the target object based on the first information and returns the second information of the target object in the second system and an association relationship between the second information and the first information. In some embodiments, the first information requested in the browser plug-in is associated with data in the second system, such as product data, by means of accurate query, search, etc. The server may be a server of the second system, and obtains the second information and returns it to the browser plug-in together with the association relationship. Specifically, the second system may first determine whether the first information has an associated target object according to the first information, and then return the second information of the target object and the association relationship with the first information to the browser plug-in if there is an associated object. This is due to the fact that the page opened by the browser may have multiple target objects therein, the first information is the first information of the target object, and there are possibly multiple target objects on the first page. Therefore, it is necessary to return the association relationship together to prevent the browser plug-in from not knowing with which target object the returned situation information is associated.

In some embodiments of the present disclosure, determining, by the server, the target object based on the first information includes: determining whether there is an object having a mapping relationship with the first information based on a predetermined mapping relationship; if yes, determining the object having the mapping relationship with the first information as the target object; otherwise, querying based on the first information, and if the target object is found, establishing the mapping relationship between the first information and the target object, and if no target object is found, determining that there is no target object.

In some embodiments, the first system and the second system may be systems authorized in advance. The first system and the second system establish the mapping relationship between the information in advance according to the authorization therebetween, and the mapping relationship is established between the name and identification of the same object in the first system and the second system (since the name of the same product in different systems may be different, and the product identification in different systems may also be different). In this way, the mapped name or identification of the same object in the second system can be determined according to the name or identification thereof in the first system. After obtaining the first information, it is first tried to determine whether the target object in the second system can be found according to the mapping relationship. If the target object can be found according to the mapping relationship, the second information of the target object is continued to be obtained. If no target object is found through the mapping relationship, searching is tried in the second system according to the first information. If the target object can be searched, the mapping relationship between the first information and the target object in the second system will be established, so that the mapping relationship is updated and maintained in real time. For example, in a business flow, if a product is found, it will be marked with a corresponding product code. The second system will automatically associate with an internal product according to the first information. If no marked product is found, the second system will try to associate with the first information according to other internal information, such as product names and product brief introductions of the products, or fuzzy query is performed on the products by the first information, and association is made if the product is found. If the target object is still not searched, it is indicated that there is no associated target object in the second system, and at this point, the second information may include: there is no associated target object in the second system.

In some embodiments of the present disclosure, displaying, on the first page, the control associated with the second information if the first page is displayed in the browser includes: injecting front-end codes on the first page according to the authorization obtained in advance to generate the control. In some embodiments, the browser plug-in injects the specific front-end codes into the first page according to the second information returned by the second system to generate the control, such as a button, a floating window and other components. The browser plug-in will provide different controls according to the difference of the situation information, and the high cost caused by development is avoided by means of webpage injection.

In some embodiments of the present disclosure, if the first page is displayed in the browser, an associated person identification associated with the second information is displayed on the first page, and the associated person identification is used for displaying an information page of an associated person or establishing communication with the associated person after being triggered.

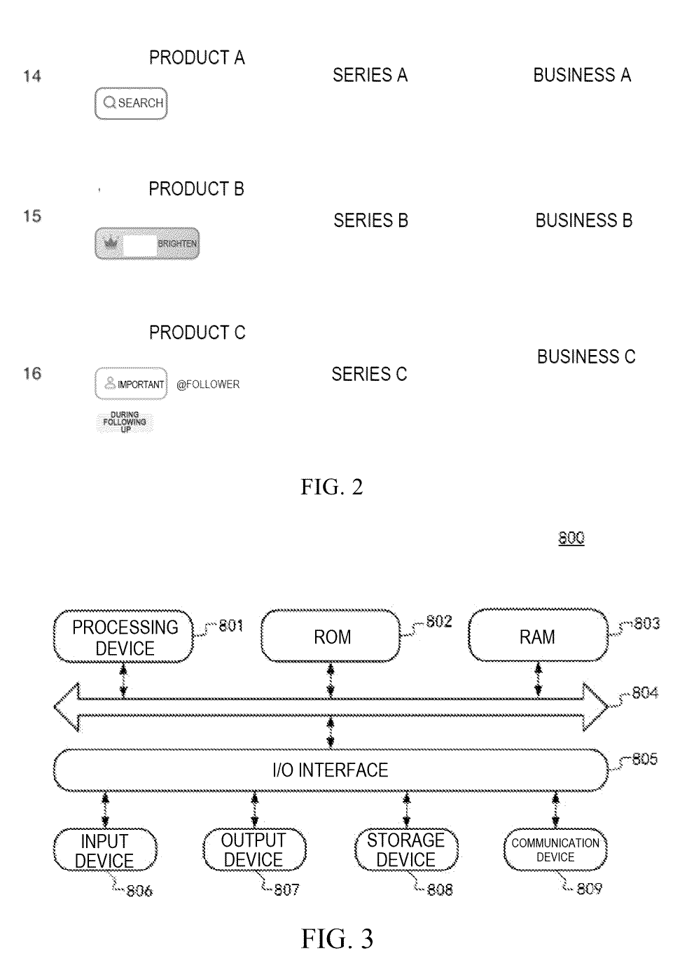

In some embodiments, taking the target object being the product as an example, the product has a follower, and the follower may be regarded as the associated person. At this point, the associated person identification is displayed on the first page, and the information page of the associated person may be displayed or a communication tool may be called to establish communication with the associated person by means of clicking or hovering a mouse over the associated person identification. The information page of the associated person may display contact information of the associated person or a business card of the associated person, which can be conveniently used for operation. For example, as shown in FIG. 2, “@ follower” is displayed in an associated area of product C on the right side of “16” as the associated person identification, and the follower may be contacted by triggering this associated person identification.

In some embodiments of the present disclosure, the information processing method further includes: in response to a triggering operation for the control, displaying content related to the second information in a page other than the first page, or jumping to a page related to the second information in the second system.

In some embodiments, the triggering operation for the control is, for example, a clicking operation. By triggering the control, the content related to the second information may be opened, but the content is displayed outside the first page to avoid data exchange with the first page, or the page related to the second information in the second system may be opened outside the first page. For example, the page related to the second information may be displayed by means of a pop-up window. For different second information, different pages may be displayed. For example, if the target object is a product in the second system, the information such as an introduction and a follow-up record of the product may be displayed after the control is triggered, and if there is an associated person, the associated person identification may also be displayed, and the contact information pops up or the communication connection is established after the user clicks the associated person identification, thereby facilitating operation of the user. In some embodiments, the browser plug-in opens a page in the second system, such as a call-up form, data entry and an information display interface. The plug-in may open the page of the second system in the form of an embedded webpage, and such an opening manner does not need actual communication with a webpage of the first system, thus ensuring data security of the second system. In some embodiments, the page other than the first page is a plug-in self-owned page. In some embodiments, the page other than the first page is a floating window page.

In some embodiments, the operation performed by the user in the page other than the first page is synchronized into the second system. For example, the operation performed by the user in the page of the second system opened by the plug-in is synchronized to the second system. In this way, the user can also perform the operation in the second system when browsing the first page without a need of repeated switching between the first system and the second system.

In some embodiments of the present disclosure, jumping to the page related to the second information in the second system includes: if the second information shows that there is no target object associated with the first information in the second system, then the control is used for displaying an information search page of the second system after being triggered; or, if the second information shows that there is a target object associated with the first information in the second system, then the control is used for opening a business processing page associated with the target object in the second system according to the second information after being triggered.

In some embodiments, if there is no target object in the second system, then the control for searching may be displayed in the currently opened page. For example, a search box may be displayed. Therefore, the user can manually search in the second system in the search box. As shown in FIG. 2, the search box is displayed below product A. If there is a target object in the second system, the control is used for opening the business processing page of the target object in the second system after being triggered. Specifically, the business processing page is a page that processes the business associated with the target object. For example, if the target object is an object being followed up, then the business processing page may be a follow-up item processing page, and the business processing page is related to the second information of the target object. If the target object is a product, then the situation information may include, for example, that a research and development center has not started production, has completed research and development and is during following up, or has completed production, and so on. The business processing pages corresponding to different situation information may be different. In this way, the user can process the target object in the second system when browsing the page of the first system without a need of jumping to the second system. For example, business personnel may view the most recently updated product information on the first system, the browser plug-in determines which products have been researched and developed and which products are potentially researched and developed according to the names or codes of the products browsed in the webpage, and provides the control. Then the business processing page may be called up by clicking the control to maintain the products, and the maintenance operation on the business processing page will be synchronized to the second system.

In some embodiments of the present disclosure, opening the business processing page associated with the target object in the second system according to the second information includes: determining the displayed business processing page from the pages shown as follows according to the second information: an information display page, an information entry page, an information editing page and an information sending page. In some embodiments, different business processing pages are opened under different situation information. The information display page is used for displaying related information of the target object, the information entry page is used for entering the related information of the target object, the information editing page is used for editing existing information, and the information sending page is used for sending the information to a receiver. In an embodiment of the present disclosure, according to different situation information, in addition to displaying the related information of the target object, business flow processing may also be performed without a need of repeated jumping by the user between the first system and the second system, thus improving the efficiency.

In some embodiments of the present disclosure, the method further includes: generating suggestion information based on the second information and displaying the suggestion information in the first page. In some embodiments, the browser plug-in will generate matched suggestion information according to the second information, so as to guide the user to perform related operations. For example, if the target object is a product, the browser plug-in will query and suggest to the current user that the product has updated production progress information in the system for follow-up, or if the browser detects that the test information of the product has been updated and the user has made a report according to the test information before the update, the suggestion information may be displayed and the user is suggested to update the report according to the updated test information.

In some embodiments of the present disclosure, the target object is displayed in the first page, the first information is the information of the target object, and the control is displayed in the associated area of the target object. In some embodiments, the first information is the information of the target object in the first page, the target object may be, for example, various products shown in FIG. 2, and the control may correspond to the target object. Therefore, the control is displayed in the associated area of the target object, so that the user can know to which target object the control belongs.

In some embodiments of the present disclosure, a display style of the control is related to the function of the control, and the controls of different functions have different display styles. In some embodiments, different display styles are set for the controls of different functions in advance, so that the user determines that the function of the control has changed from the style of the control.

In some embodiments of the present disclosure, characters and/or patterns are displayed in the control, the characters and/or patterns are related to the function of the control, and the controls of different functions have different characters and/or patterns. In some embodiments, as shown in FIG. 2, there are characters and patterns in the control to help the user understand the function of the control.

In some embodiments, the second information includes at least one of the following: information about whether the target object has a specific attribute (for example, whether the product is a hardware product or a software product), importance information of the target object, and business progress information related to the target object. In some embodiments, the specific attribute information may be, for example, the type of the target object, the region where the target object is located, and the like. Different target objects may have the importance information. For different importance information, the controls of different functions may be provided. The business progress information related to the target object may be, for example, product development progress, production progress, test progress, etc. The controls provided for different progress information may have different functions. For example, the control provided in a research and development stage may be used for uploading related reference materials, and the control provided in a test stage may be used for making test reports, and so on.

In some embodiments, as shown in FIG. 2, the number of the target objects is one or more, and the number of the controls is one or more; the target object is associated with the control, one of the controls is associated with one of the target objects, and one of the target objects is associated with one or more controls.

In some embodiments of the present disclosure, the first system provides analysis, query, correlation, comparison and other capabilities. In this way, when opening the first page in the first system, the user can view the information of the target object with these capabilities to, and can view the information of the related target object in the second system based on capabilities of the browser plug-in at the same time. More importantly, the operations related to the information of the target object can be performed in the first page through the control, without a need of frequent switching between the two systems and looking for and operating the control, which greatly improves the efficiency.

An embodiment of the present disclosure also provides an information processing apparatus, which may be a plug-in of a browser specifically and includes an obtaining unit for obtaining first information of a first page of a first system;
a determination unit for determining, in a second system, second information associated with the first information based on the first information; and
a display unit for displaying, on the first page, a control associated with the second information if the first page is displayed in the browser;
wherein a function of the control is related to the second information.

In some embodiments, obtaining the first information of the first page of the first system includes:
obtaining, if the first page of the first system meets a predetermined condition, the first information of the first page from a broadcast event performed by the first system through the browser; or,
parsing the first page to obtain the first information.

In some embodiments, the predetermined condition includes one or more of the following: the browser loading the first page; and a change of the content in the first page.

In some embodiments, if the first page is displayed in the browser, a target object is displayed on the first page; and the first information includes information of the target object.

In some embodiments, displaying the control associated with the second information on the first page includes: displaying the control at an associated position of the target object on the first page.

In some embodiments, determining the second information associated with the first information in the second system includes:

transmitting the first information to a server, so that the server determines the target object based on the first information, and returns situation information of the target object in the second system and an association relationship between the situation information and the first information.

In some embodiments, determining, by the server, the target object based on the first information includes:
determining, based on a predetermined mapping relationship, whether there is an object having a mapping relationship with the first information;
if yes, determining the object having the mapping relationship with the first information as the target object; and
otherwise, querying based on the first information, and if the target object is found, establishing the mapping relationship between the first information and the target object, and if no target object is found, determining that there is no target object.

In some embodiments, displaying, on the first page, the control associated with the second information if the first page is displayed in the browser includes:
injecting front-end codes into the first page to generate the control.

In some embodiments, the display unit is further used for displaying, on the first page, an associated person identification associated with the second information if the first page is displayed in the browser;
the associated person identification being for displaying an information page of an associated person or establishing communication with the associated person after being triggered.

In some embodiments, the display unit is further used for displaying, in response to a triggering operation for the control, content related to the second information in a page other than the first page, or jumping to a page related to the second information in the second system.

In some embodiments, the page other than the first page is a self-owned page of the plug-in; and in some embodiments, the page other than the first page is a floating window page.

In some embodiments, a synchronization unit is further included and used for synchronizing an operation performed by a user in the page other than the first page into the second system.

In some embodiments, jumping to the page related to the second information in the second system includes:
if the second information shows that there is no target object associated with the first information in the second system, then the control is used for displaying an information search page of the second system after being triggered; or,
if the second information shows that there is a target object associated with the first information in the second system, then the control is used for opening a business processing page associated with the target object in the second system according to the second information after being triggered.

In some embodiments, opening, according to the second information, the business processing page associated with the target object in the second system includes:
determining, according to the second information, the displayed business processing page from the pages shown as follows: an information display page, an information entry page, an information editing page and an information sending page.

In some embodiments, the display unit is further used for generating, based on the second information, suggestion information and displaying the suggestion information in the first page.

In some embodiments, at least one of the following is satisfied:
a display style of the control is related to the function of the control, and the controls of different functions have different display styles; and
characters and/or patterns are displayed in the control, the characters and/or patterns are related to the function of the control, and the controls of different functions have different characters and/or patterns; and
the second information includes at least one of the following: information about whether the target object has a specific attribute; importance information of the target object; and business progress information of the target object.

In some embodiments, the number of the target objects is one or more, and the number of the controls is one or more; and
the target object is associated with the control, one of the controls is associated with one of the target objects, and one of the target objects is associated with one or more controls.

Since the apparatus embodiments basically correspond to the method embodiments, it is only necessary to refer to partial descriptions of the method embodiments for related parts. The apparatus embodiments described above are merely schematic, wherein the modules described as separate modules may or may not be separate. Part or all of the modules may be selected according to actual needs to achieve objectives of the solution of the embodiments, which can be understood and implemented by those ordinary skilled in the art without creative labor.

In the above, the method and apparatus according to the present disclosure have been described based on the embodiments and the application examples. In addition, the present disclosure also provides a terminal and a computer storage medium, which are described below.

Refer to FIG. 3, which shows a schematic diagram of an electronic device 800 according to an embodiment of the present disclosure. The terminal device in the embodiment of the present disclosure may include but is not limited to a mobile terminal, such as a mobile phone, a notebook computer, a digital broadcast receiver, a personal digital assistant (PDA), a tablet computer (PAD), a portable multimedia player (PMP), an onboard terminal (such as an onboard navigation terminal), and a fixed terminal, such as a digital TV and a desktop computer. The electronic device shown in FIG. 3 is only an example, and should not limit the function and disclosure range of the embodiments of the present disclosure.

As shown in FIG. 3, the electronic device 800 may include a processing apparatus (such as a central processing unit, a graphics processing unit, or the like) 301 that may perform various appropriate actions and processing according to a program stored in a read-only memory (ROM) 802 or a program loaded from a storage apparatus 808 into a random-access memory (RAM) 803. In the RAM 803, various programs and data required for operation of the electronic device are further stored. The processing apparatus 801, the ROM 802, and the RAM 803 are connected to each other by using a bus 804. An input/output (I/O) interface 805 is also connected to the bus 804.

Generally, the following apparatuses may be connected to the I/O interface 805: input apparatuses 806 including, for example, a touchscreen, a touchpad, a keyboard, a mouse, a camera, a microphone, an accelerometer, and a gyroscope; output apparatuses 807 including, for example, a liquid crystal display (LCD), a loudspeaker and a vibrator; storage apparatuses 808 including, for example, a tape or a hard disk; and a communications apparatus 809. The communications apparatus 809 may allow the electronic device to communicate wirelessly or wiredly with another device to exchange data. Although FIG. 3 shows an electronic device 800 with various apparatuses, it should be understood that it is not required to implement or provide all shown apparatuses. Alternatively, more or fewer apparatuses may be implemented or provided.

In particular, according to the embodiments of the present disclosure, the process described above with reference to the flowchart may be implemented as a computer software program. For example, an embodiment of the present disclosure includes a computer software program product that includes a computer program carried on a readable medium, and the computer program includes program codes used to perform the methods shown in the flowchart. In such an embodiment, the computer program may be downloaded and installed from a network by using the communications apparatus 809, installed from the storage apparatus 808, or installed from the ROM 802. When the computer program is performed by the processing apparatus 801, the foregoing functions defined in the method in the embodiments of the present disclosure are performed.

It should be noted that the foregoing computer-readable medium in the present disclosure may be a computer-readable signal medium, a computer-readable storage medium, or any combination of the two. The computer-readable storage medium may be, for example, an electrical, magnetic, optical, electromagnetic, infrared, or semiconductor system, apparatus, or device, or any combination thereof. More specific examples of the computer-readable storage medium may include but are not limited to: an electrical connection having one or more conducting wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. In the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or device. The program code included in the computer-readable medium may be transmitted by using any suitable medium, including but not limited to: a wire, an optical cable, a radio frequency (RF), or any suitable combination thereof.

In some embodiments, the client and the server can communicate by using any currently known or future-developed network protocol, for example, an HTTP (Hyper Text Transfer Protocol), and can be interconnected by a communication network of any form or any medium. Examples of the communication network include a local area network (LAN), a wide area network (WAN), an internet network (for example, the Internet), and an end-to-end network (for example, an ad hoc end-to-end network), and any currently known or future-developed network.

The computer readable medium may be included in the foregoing electronic device, or may exist separately and not be assembled into the electronic device.

The computer readable medium stores one or more programs. When the one or more programs is/are performed by the electronic device, the electronic device is caused to perform the above methods of the present disclosure.

Computer program codes for performing the operations of the present disclosure may be written in one or more programming languages or a combination thereof, such as object-oriented programming languages Java, Smalltalk, C++, and conventional procedural programming languages such as “C” or similar program design languages. The program codes may be performed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

Flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be performed in substantially parallel, and they may sometimes be performed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units described in embodiments of the present disclosure may be implemented either by means of software or by means of hardware. The names of these units do not limit the units themselves under certain circumstances.

Various functions described herein above can be implemented by one or more hardware logic members. For example and without limitations thereto, an exemplary hardware logic member includes a field programmable gate array (FPGA), an disclosure-specific integrated circuit (ASIC), an disclosure-specific standard product (ASSP), a system-on-chip system (SOC), a complex programmable logic device (CPLD) or the like.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. Machine-readable media may include, but are not limited to, electronic, magnetic, optical, electromagnetic, infrared, or semiconductor systems, apparatuses or devices, or any suitable combination of the foregoing. More specific examples of machine-readable storage media would include one or more wire-based electrical connections, portable computer disks, hard disks, random-access memories (RAMs), read-only memories (ROMs), erasable programmable read-only memories (EPROM or flash memories), fiber optics, portable compact disk read only memories (CD-ROMs), optical storage devices, magnetic storage devices, or any suitable combination of the foregoing.

According to one or more embodiments of the present disclosure, an information processing method is provided and includes the following steps performed by a plug-in of a browser:
obtaining first information of a first page of a first system;
determining, in a second system, second information associated with the first information based on the first information; and
displaying, on the first page, a control associated with the second information if the first page is displayed in the browser;
wherein a function of the control is related to the second information.

According to one or more embodiments of the present disclosure, an information processing method is provided, and obtaining the first information of the first page of the first system includes:
obtaining the first information of the first page from a broadcast event performed by the first system through the browser if the first page of the first system meets a predetermined condition; or,
parsing the first page to obtain the first information.

According to one or more embodiments of the present disclosure, an information processing method is provided, and the predetermined condition includes one or more of the following: the browser loading the first page; and a change of the content in the first page.

According to one or more embodiments of the present disclosure, an information processing method is provided, and if the first page is displayed in the browser, a target object is displayed on the first page; and
the first information includes information of the target object.

According to one or more embodiments of the present disclosure, an information
processing method is provided, and displaying, on the first page, the control associated with the second information includes: displaying the control at an associated position of the target object on the first page.

According to one or more embodiments of the present disclosure, an information processing method is provided, and determining, in the second system, the second information associated with the first information includes:
transmitting the first information to a server, so that the server determines the target object based on the first information, and returns situation information of the target object in the second system and an association relationship between the situation information and the first information.

According to one or more embodiments of the present disclosure, an information processing method is provided, and determining, by the server, the target object based on the first information includes:
determining, based on a predetermined mapping relationship, whether there is an object having a mapping relationship with the first information;
if yes, determining the object having the mapping relationship with the first information as the target object; and
if not, querying based on the first information, and if the target object is found, establishing the mapping relationship between the first information and the target object, and if no target object is found, determining that there is no target object.

According to one or more embodiments of the present disclosure, an information processing method is provided, and displaying, on the first page, the control associated with the second information if the first page is displayed in the browser includes: injecting front-end codes into the first page to generate the control.

According to one or more embodiments of the present disclosure, an information processing method is provided, and the method further includes:
displaying, on the first page, an associated person identification associated with the second information if the first page is displayed in the browser;
the associated person identification being for displaying an information page of an associated person or establishing communication with the associated person after being triggered.

According to one or more embodiments of the present disclosure, an information processing method is provided, and the method further includes: displaying, in response to a triggering operation for the control, content related to the second information in a page other than the first page, or jumping to a page related to the second information in the second system.

According to one or more embodiments of the present disclosure, an information processing method is provided, and the page other than the first page is a self-owned page of the plug-in;
and/or, the page other than the first page is a floating window page.

According to one or more embodiments of the present disclosure, an information processing method is provided, and an operation performed by a user in the page other than the first page is synchronized into the second system.

According to one or more embodiments of the present disclosure, an information processing method is provided, and jumping to the page related to the second information in the second system includes:
if the second information shows that there is no target object associated with the first information in the second system, then the control is used for displaying an information search page of the second system after being triggered; or,
if the second information shows that there is a target object associated with the first information in the second system, then the control is used for opening a business processing page associated with the target object in the second system according to the second information after being triggered.

According to one or more embodiments of the present disclosure, an information processing method is provided, and opening, according to the second information, the business processing page associated with the target object in the second system includes:
determining, according to the second information, the displayed business processing page from the pages shown as follows: an information display page, an information entry page, an information editing page and an information sending page.

According to one or more embodiments of the present disclosure, an information processing method is provided, and further includes:
generating, based on the second information, suggestion information and displaying the suggestion information in the first page.

According to one or more embodiments of the present disclosure, an information processing method is provided, and at least one of the following is satisfied:
a display style of the control is related to the function of the control, and the controls of different functions have different display styles;
characters and/or patterns are displayed in the control, the characters and/or patterns are related to the function of the control, and the controls of different functions have different characters and/or patterns; and
the second information includes at least one of the following: information about whether the target object has a specific attribute; importance information of the target object; and business progress information of the target object.

According to one or more embodiments of the present disclosure, an information processing method is provided, the number of the target objects is one or more, and the number of the controls is one or more; and
the target object is associated with the control, one of the controls is associated with one of the target objects, and one of the target objects is associated with one or more controls.

According to one or more embodiments of the present disclosure, an information processing apparatus is provided and includes:
an obtaining unit for obtaining first information of a first page of a first system;
a determination unit for determining, in a second system, second information associated with the first information based on the first information; and
a display unit for displaying, on the first page, a control associated with the second information if the first page is displayed in a browser;
wherein a function of the control is related to the second information.

According to one or more embodiments of the present disclosure, a terminal is provided and includes: at least one memory and at least one processor;
wherein the at least one memory is used for storing program codes, and the at least one processor is used for calling the program codes stored by the at least one memory to perform any above method.

According to one or more embodiments of the present disclosure, a computer-readable storage medium is provided. The computer-readable storage medium is used for storing program codes which, when performed by a processor, cause the processor to perform any above method.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Furthermore, while the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logical actions, it should be understood that the subject matter limited in the appended claims is not necessarily limited to the particular features or actions described above. Rather, the particular features and actions described above are merely example forms of implementing the claims.

1. An information processing method, comprising the following steps performed by a plug-in of a browser:
obtaining first information of a first page of a first system;
determining, based on the first information, second information associated with the first information in a second system; and
in response to the first page being displayed in the browser, displaying a control associated with the second information on the first page;
wherein a function of the control is related to the second information.

2. The method of claim 1, wherein obtaining first information of a first page of a first system comprises:
in response to a first page of a first system satisfying a predetermined condition, obtaining the first information of the first page from a broadcast event performed by a first system through a browser; or,
parsing the first page to obtain the first information.

3. The method of claim 2, wherein the predetermined condition comprises one or more of the following:
a browser loading the first page; and
a change of content in the first page.

4. The method of claim 1, wherein
in response to the first page being displayed in the browser, a target object is displayed on the first page; and
the first information comprises: information of the target object.

5. The method of claim 4, wherein
displaying, on the first page, a control associated with the second information comprises: displaying, on the first page, the control on an associated position of the target object.

6. The method of claim 1, wherein determining the second information associated with the first information in the second system comprises:
transmitting the first information to a server, to cause the server to determine a target object based on the first information and to return situation information of a target object in the second system and an association relationship between the situation information and the first information.

7. The method of claim 6, wherein determining, by the server, a target object based on the first information comprises:
determining, based on a predetermined mapping relationship, whether there is an object having a mapping relationship with the first information;
if yes, determining an object having a mapping relationship with the first information as the target object; and
otherwise, querying based on the first information, if the target object is found, establishing a mapping relationship between the first information and the target object, and if no target object is found, determining that no target object exist.

8. The method of claim 1, wherein the method further comprises:
in response to the first page being displayed in the browser, displaying, on the first page, an associated person identification associated with the second information;
the associated person identification being used for displaying an information page of an associated person or establishing communication with the associated person after being triggered.

9. The method of claim 1, wherein the method further comprises:
in response to a triggering operation for the control, displaying content related to the second information in a page other than the first page, or jumping to a page related to the second information in the second system.

10. The method of claim 9, wherein
a page other than the first page is a self-owned page of the plug-in;
and/or
a page other than the first page is a floating window page.

11. The method of claim 9, wherein
an operation performed by a user in a page other than the first page is synchronized into the second system.

12. The method of claim 9, wherein jumping to a page related to the second information in a second system comprises:
if the second information shows that a target object associated with the first information is missing in the second system, the control is used for displaying an information search page of the second system after being triggered; or,
if the second information shows that a target object associated with the first information exists in the second system, then the control is used for opening a business processing page associated with the target object in the second system according to the second information after being triggered.

13. The method of claim 12, wherein opening, according to the second information, a business processing page associated with the target object in the second system comprises:
determining, according to the second information, the displayed business processing page from following pages: an information display page, an information input page, an information editing page and an information sending page.

14. The method of claim 1, further comprising:
generating suggestion information based on the second information and displaying the suggestion information in the first page.

15. The method of claim 1, wherein at least one of the following is satisfied:
a display style of the control is related to a function of the control, and controls of different functions have different display style; and
a character and/or a pattern is displayed in the control, the character and/or pattern being is to a function of the control, and controls of different functions have different characters and/or patterns.

16. The method of claim 4, wherein the second information comprises at least one of the following:
information regarding whether the target object has a specific attribute;
importance information of the target object; and
business progress information related to the target object.

17. The method according to claim 4, wherein
a number of the target object is one or more; a number of the control is one or more; and
the target object is associated with the control, one control being associated with one target object, one target object being associated with one or more controls.

18-20. (canceled)

21. A terminal comprising:
at least one memory and at least one processor;
wherein the at least one memory is used for storing program code; the at least one processor is used for invoking program code stored by the at least one memory to perform the a method comprising:
obtaining first information of a first page of a first system;
determining, based on the first information, second information associated with the first information in a second system; and
in response to the first page being displayed in the browser, displaying a control associated with the second information on the first page;
wherein a function of the control is related to the second information.

22. A terminal according to claim 21, wherein obtaining first information of a first page of a first system comprises:
in response to a first page of a first system satisfying a predetermined condition, obtaining the first information of the first page from a broadcast event performed by a first system through a browser; or,
parsing the first page to obtain the first information.

23. A non-transitory computer-readable storage medium for storing program code, in response to the program code being executed by a processor, cause a processor to perform a method comprising:
obtaining first information of a first page of a first system;
determining, based on the first information, second information associated with the first information in a second system; and
in response to the first page being displayed in the browser, displaying a control associated with the second information on the first page;
wherein a function of the control is related to the second information.
